(19) United States
(12) Patent Application Publication
(10) Pub. No.: US 2009/0015171 A1
(43) Pub. Date: Jan. 15, 2009

(54) BACKLIGHT SYSTEM

(75) Inventor: Chih-Chan GER, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/168,847

(22) Filed: Jul. 7, 2008

(30) Foreign Application Priority Data
Jul. 12, 2007 (CN) 200720200648.9

(51) Int. Cl. H05B 37/02

(52) U.S. Cl. 315/201

(57) ABSTRACT

The backlight system comprises a light source module, a control circuit board, a current-balancing circuit board, and a plurality of high voltage lines. The light source module comprises a plurality of light sources. The control circuit board is configured with a control circuit for converting a received signal to a high voltage signal to drive the light source module. The current-balancing circuit board is configured with a four-layered structure and copper foils within the four-layered structure form a plurality of capacitors so as to balance current flowing through the light sources. The plurality of high voltage lines connect the control circuit board to the current-balancing circuit board.

### BACKGROUND

1. Field of the Invention

Embodiments of the present disclosure relate to backlight systems, and more particularly, to a backlight system used in liquid crystal display (LCD).

2. Description of Related Art

Discharge lamps, such as cold cathode fluorescent light sources (CCFLs), are often used as light sources in LCD panels. A backlight system is often employed in LCD panels to control the light sources in the LCD panel. However, LCD panels have become larger in size and, correspondingly, the number of light sources needed in LCD panels have increased causing a difference in impedance in the number of light sources. Some systems include a backlight system that uses a current-balancing component to balance current flowing through the light sources.

FIG. 4A and FIG. 4B illustrate one example of a backlight system 4 that uses current-balancing to balance current flowing through a plurality of light sources 43. The backlight system 4 of FIG. 4A and FIG. 4B comprises a control circuit board 41, a first light source connecting board 42, a second light source connecting board 44 and a plurality of light sources 43. Each of the plurality of light sources 43 comprises a capacitor 420 located on a first end of each of the light sources 43 and the capacitor 420 located on a second end of each of the light sources 420. However, the capacitors 420 of the system of FIG. 4 are typically expensive component capacitors, such as surface mount technology (SMT) capacitor or dip capacitors in order to function.

In operation, the control circuit 410 converts a received electrical signal into a high voltage signal to drive the light sources 43 via the first light source connecting board 42. The high voltage signal causes a voltage drop on each of the capacitors 420 is substantially the same as voltage added to the light sources 43, and because the light source connecting board is typically a two-layered structure which the two layers are parallel to each other, the capacitors 420 require a long distance to each other to meet the voltage tolerance requirements in order to avoid arcing. Thus, two light source connecting boards are needed to arrange the capacitors 420.

Furthermore, the light sources 43 can only be an in-phase array to adjust the voltage difference between neighboring light sources to be zero, thereby avoiding arcing. However, this array will cause the light sources to have a water rippling effect. If these conditions aren't met with regards to the voltage tolerance and security of the light source connecting board, the conventional backlight system 4 cannot set a protection circuit, which may lead to a low level of security.

### SUMMARY

One aspect of the invention provides a backlight system. The backlight system comprises a light source module, a control circuit board, a current-balancing circuit board and a plurality of high voltage lines. The light source module comprises a plurality of light sources. The control circuit board is configured with a control circuit for converting a received signal to a high voltage signal to drive the light source module. The current-balancing circuit board is configured with a four-layered structure, wherein copper foils within the four-layered structure form a plurality of capacitors so as to balance current flowing through the light sources. The plurality of high voltage lines connects the control circuit board to the current-balancing circuit board.

Other advantages and novel features will become more apparent from the following detailed description when taken in conjunction with the accompanying drawings, in which:

### BRIEF DESCRIPTION OF THE DRAWINGS

FIG. 1A and FIG. 1B illustrate one embodiment of a backlight system 1 of the present disclosure;

FIG. 2A and FIG. 2B illustrate another embodiment of a backlight system 2 of the present disclosure;

FIG. 3A and FIG. 3B illustrate another embodiment of a backlight system 3 of the present disclosure;

FIG. 4A and FIG. 4B illustrate one example of a backlight system 4;

### DETAILED DESCRIPTION OF THE EMBODIMENTS

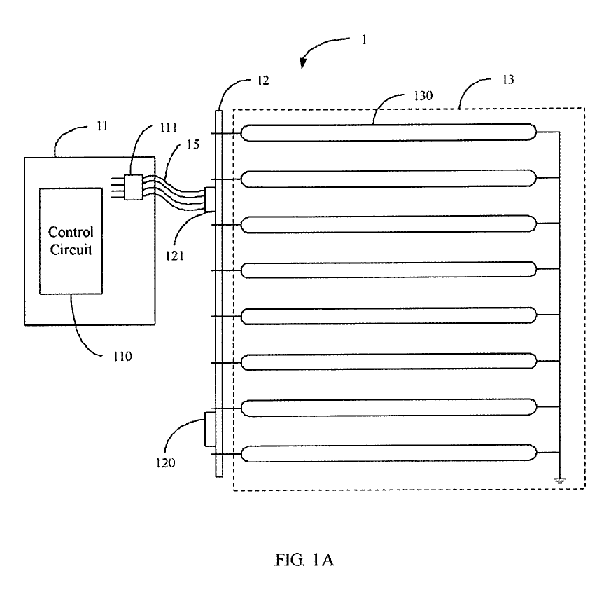

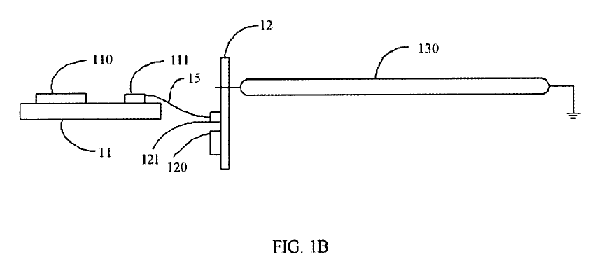

FIG. 1A and FIG. 1B illustrate one embodiment of a backlight system 1 of the present disclosure. The backlight system 1 may be used to deliver controlled light to a display (not shown). In one embodiment, the backlight system 1 comprises a control circuit board 11, a current-balancing circuit board 12 and a light source module 13. The light source module 13 comprises a plurality of light sources 130, such as discharge lamps, which are located in parallel to each other.

The control circuit board 11 is electrically connected to the current-balancing circuit board 12 through a plurality of high voltage lines 15 connecting the first connector 111 to the second connector 121. A control circuit 110 converts a received signal into a high voltage signal. The plurality of high voltage lines 15 transfer the high voltage signal output from the control circuit 110 to the current-balancing circuit board 12 in order to drive the light sources 130. The current-balancing circuit board 12 is located on a first side of the light sources 130 and is substantially perpendicular to the light sources 130.

The current-balancing board 12 may flow and balance current to the light sources 130 via a plurality of capacitors (not shown) embedded in the current-balancing board 12. In one embodiment, the current-balancing circuit board 12 comprises a protection circuit 120 for protecting the light sources 130 from high voltages. In the embodiment of FIG. 1A and FIG. 1B, the current-balancing circuit board 12 is configured with a four-layered structure and copper foils within two middle layers of the four-layered structure form a plurality of embedded capacitors (not shown). In another embodiment, the current-balancing circuit board 12 can also be configured with a six-layered structure with substantially the same configuration as the four-layered structure. In one embodiment, one capacitor may correspond to one of the light sources 130. For example, if the light sources 130 comprise seven discharge lamps, then seven capacitors may be needed with each of the seven discharge lamps comprising one capacitor.

In one embodiment, a first end of the light sources 130 is connected to the current-balancing circuit board 12, while a second end of the light sources 130 is grounded. In another embodiment, the second end may be connected to a feedback circuit (not shown) for flowing current back to the control circuit 110 to control the output thereof. In another embodiment, a distal end of two neighboring light sources of the light sources 130 may be connected together to form a U-shaped light source.

In one embodiment, the capacitors embedded in the current-balancing circuit board 12 have a high impedance value. As a result of the high impedance value, a voltage drop across the current-balancing board 12 may be substantially the same as those added to the light sources 130. Thus, if the impedance of the light sources 130 changes, the total impedance of the light sources 130 and the embedded capacitors may only change a small amount. As a result, currents flowing through the light sources 130 are may not change substantially. Since the capacitors and the high voltage lines are embedded in the current-balancing circuit board 12, the backlight system 1 simply requires a short distance to meet high voltage tolerance requirements of the light sources 130. In the embodiment of FIG. 1, the backlight system 1 uses one current-balancing circuit board 12. However, depending on the embodiment, the backlight system 1 may use two current-balancing circuit boards 12.

Since the capacitors are embedded in the current-balancing circuit board 12, the protection circuit 120 protects the light sources 130 from high voltages thus allowing the backlight system 1 to have a higher level of security. It may be understood that the higher level of security protects the light sources 130 and the current-balancing board 12 from experiencing a high voltage and/or current load which may damage the light sources 130 and/or the current-balancing board 12.

In one embodiment, neighboring light sources of the light sources 130 may be configured to alternate between positive and negative phases so as to avoid the so-called “water-rippling effect” of the light sources 130.

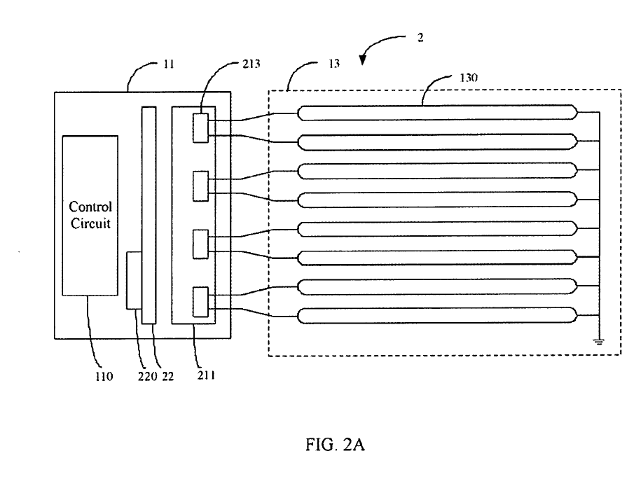

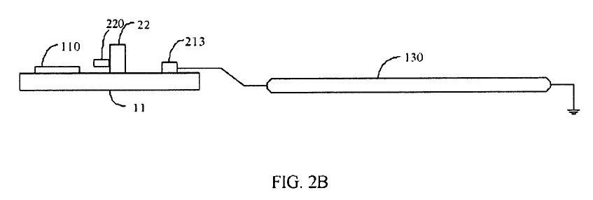

FIG. 2A and FIG. 2B illustrate another embodiment of a backlight system 2 of the present disclosure comprising a protection circuit 220, a current-balancing board 22, and a connector circuit 211. In one embodiment, the connector circuit 211 comprises a plurality of connectors 213 electrically connecting the control circuit 110 to the light source module 13. Each of the connectors 213 comprises two high voltage lines electrically connecting two light sources to the control circuit 110. The current-balancing circuit board 22 may be substantially perpendicular to the control circuit board 11.

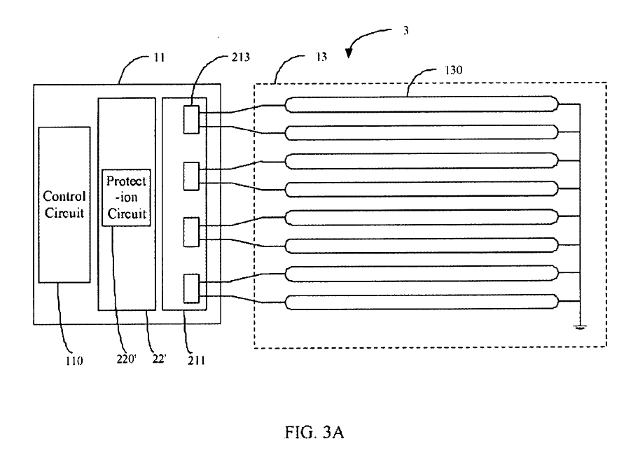

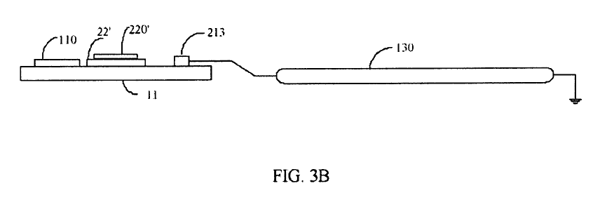

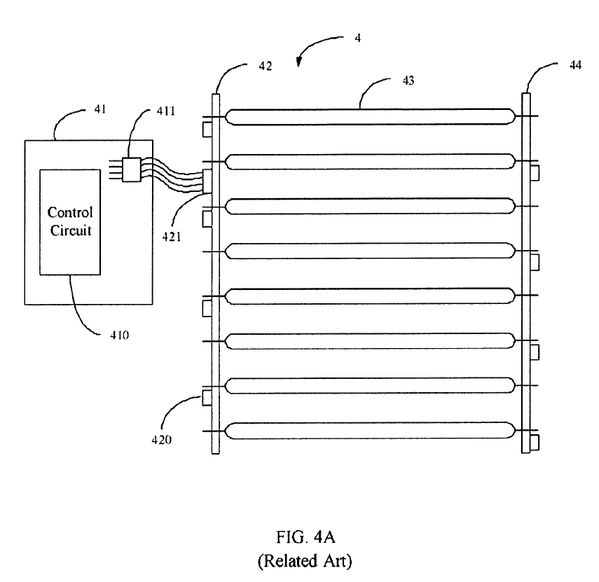

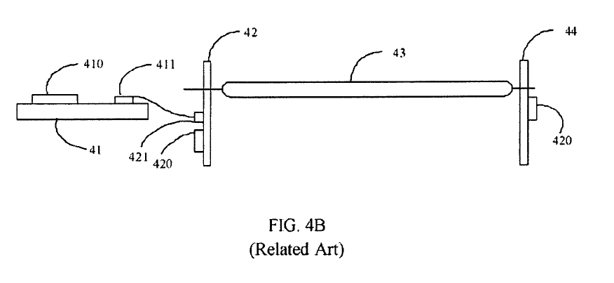

FIG. 3A and FIG. 3B illustrate another embodiment of a backlight system 3 of the present disclosure. The backlight system 3 of FIG. 3A is substantially the same as that of FIG. 2A, with the exception that a current-balancing circuit board 22′ and a protection circuit 20′ is substantially parallel to the control circuit board 11.

In the present disclosure, the backlight system 1, 2, 3 uses the current-balancing circuit board 12, 22, 22′ configured with a four-layered or six-layered structure. It may be understood that the four-layered or six-layered structure comprises an inner two middle layers where copper foils within the inner two middle layers to form a plurality of capacitors for balancing currents flowing through the light sources 130. The plurality of capacitors formed in the copper foils allow for lower manufacturing costs as dedicated capacitors may not be required. Additionally, the capacitors are embedded in the current-balancing circuit board 12, 22, 22′ for improved voltage tolerance. Furthermore, the simple design of the protection circuit 120, 220, 220′ allows the entire circuit 11 to have a higher level of security. Furthermore, neighboring light sources from the light sources 130 may be configured to alternate between positive and negative phases to avoid water-rippling effects.

It is believed that the present inventive embodiments and their advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A backlight system comprising:
a light source module comprising a plurality of light sources;
a control circuit board configured with a control circuit for converting a received signal into a high voltage signal for driving the plurality of light sources;
a current-balancing circuit board configured with a four-layered structure, wherein copper foils within the four-layered structure form a plurality of capacitors so as to balance current flowing through the light sources; and
a plurality of high voltage lines connecting the control circuit board to the current-balancing circuit board.

2. The backlight system of claim 1, wherein the current-balancing circuit board is located at a first side of the light sources, and wherein the current-balancing board is substantially perpendicular to the light sources.

3. The backlight system of claim 2, further comprising a first connector, located on the control circuit board, wherein a first end of the plurality of high voltage lines is connected to the first connector.

4. The backlight system of claim 2, further comprising a second connector, located on the current-balancing circuit board, wherein a second end of the plurality of high voltage lines is connected to the second connector.

5. The backlight system of claim 1, wherein the current-balancing circuit board is located on the control circuit board.

6. The backlight system of claim 5, wherein the current-balancing circuit board is located substantially perpendicular to the control circuit board.

7. The backlight system of claim 5, wherein the current-balancing circuit board is located substantially parallel to the control circuit board.

8. The backlight system of claim 5, further comprising a connector circuit configured with a plurality of connectors connecting the control circuit board to the light sources.

9. The backlight system of claim 1, further comprising a protection circuit located on the current-balancing circuit board for outputting a protection signal to the control circuit.

10. A backlight system comprising:
a light source module comprising a plurality of light sources;
a control circuit board configured with a control circuit for converting a received signal to a high voltage signal to drive the light sources;
a current-balancing circuit board configured with a six-layered structure, wherein copper foils within the six-layered structures form a plurality of capacitors so as to balance currents flowing through the light sources; and
a plurality of high voltage lines, connecting the control circuit board to the current-balancing circuit board.

11. The backlight system of claim 10, wherein the current-balancing circuit board is located at a first side of the light sources, and is substantially perpendicular to the light sources.

12. The backlight system of claim 11, further comprising a first connector, located on the control circuit board, wherein a first end of the plurality of high voltage lines is connected to the first connector.

13. The backlight system of claim 11, further comprising a second connector, located on the current-balancing circuit board, wherein a second end of the plurality of high voltage lines is connected to the second connector.

14. The backlight system of claim 10, wherein the current-balancing circuit board is located on the control circuit board.

15. The backlight system of claim 14, wherein the current-balancing circuit board is located substantially perpendicular to the control circuit board.

16. The backlight system of claim 14, wherein the current-balancing circuit board is located substantially parallel to the control circuit board.

17. The backlight system of claim 14, further comprising a connector circuit configured with a plurality of connectors connecting the control circuit board to the light sources.

18. The backlight system of claim 10, further comprising a protection circuit located on the current-balancing circuit board for outputting a protection signal to the control circuit.
